(19) United States
(12) Patent Application Publication
(10) Pub. No.: US 2023/0375118 A1
(43) Pub. Date: Nov. 23, 2023

(54) COMMUNICATING STRUCTURE

(71) Applicant: TING-JUI WANG, New Taipei City (TW)

(72) Inventor: TING-JUI WANG, New Taipei City (TW)

(21) Appl. No.: 17/748,051

(22) Filed: May 19, 2022

(51) Int. Cl. F16L 37/373

(52) U.S. Cl. CPC F16L 37/373

(57) ABSTRACT

The present disclosure provides a communicating structure applied to a first communicating body and including a door assembly. The door assembly is assembled in the first communicating body, and includes a door movably connected to the first communicating body, and a connecting structure allowing movement of the door. The connecting structure includes an actuating portion, and the door is provided with a connecting portion. The actuating portion is for acting on the connecting portion or performing a lever operation on the connecting portion so as to move the door.

### BACKGROUND OF THE INVENTION

1. Field of the Invention

The present disclosure provides a communicating structure, and in particular to a communicating structure applied for communicating two communicating bodies.

### 2. Description of the Related Art

To connect two pipes for fluid communication of a fluid in the prior art, valves on both sides need to be first closed or it is made sure that a source that supplies the fluid is shut before the connection of the pipes can be performed. After the connection, the valves or the source that supplies the fluid is then opened to allow flowing of the fluid. As a result, such process is quite complicated.

### BRIEF SUMMARY OF THE INVENTION

With dedicated research and development, the applicant provides a communicating structure in the aim of achieving a goal of simplifying an operation process of communicating two communicating bodies.

To achieve the above and other objects, a communicating structure applied to a first communicating body and including a door assembly is provided according to a first aspect of the present disclosure. The door assembly is assembled in the first communicating body, and includes a door movably connected to the first communicating body, and a connecting structure allowing movement of the door. The connecting structure includes an actuating portion, and the door is provided with a connecting portion. The actuating portion is for acting on the connecting portion or performing a lever operation on the connecting portion so as to move the door.

A communicating structure applied to a first communicating body is provided according to a second aspect of the present disclosure. The communicating structure includes a door assembly. The door assembly is assembled in the first communicating body. The door assembly includes a door movably connected to the first communicating body. The door assembly further includes a sealing section, or the door has an opening, or the sealing section is assembled or sealed at the opening, or the sealing section is assembled or sealed at a non-door portion, so as to communicate a fluid.

Thus, by merely plugging or unplugging the first communicating body with respect to another communicating body, the first communicating body is allowed to quickly communicate with or be separated from the another communicating body, thereby achieving the goal of simplifying an operation process.

### BRIEF DESCRIPTION OF THE DRAWINGS

FIG. 1 is a first schematic diagram of a communicating structure according to a specific embodiment of the present disclosure applied for communicating a first communicating body and a second communicating body.

FIG. 2 is a partial top view and section schematic diagram corresponding to a communicating structure according to a specific embodiment of the present disclosure.

FIG. 3 is a three-dimensional schematic diagram corresponding to a communicating structure according to a specific embodiment of the present disclosure.

FIG. 4 is a second schematic diagram of a communicating structure according to a specific embodiment of the present disclosure applied for communicating a first communicating body and a second communicating body.

FIG. 5 is a first structural schematic diagram of a connecting portion and an actuating portion according to a specific embodiment of the present disclosure.

FIG. 6 is a second structural schematic diagram of a connecting portion and an actuating portion according to a specific embodiment of the present disclosure.

FIG. 7 is a three-dimensional schematic diagram of butterfly-body door according to a specific embodiment of the present disclosure.

FIG. 8 is a third schematic diagram of a communicating structure according to a specific embodiment of the present disclosure applied for communicating a first communicating body and a second communicating body.

FIG. 9 is a first schematic diagram of a communicating structure according to a specific embodiment of the present disclosure applied to a first communicating body.

FIG. 10 is a second schematic diagram of a communicating structure according to a specific embodiment of the present disclosure applied to a first communicating body.

FIG. 11 is a section schematic diagram of a communicating structure according to a specific embodiment of the present disclosure applied for communicating a first communicating body and a second communicating body.

FIG. 12 is a schematic diagram of an operation of a sealing section and a door according to a specific embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

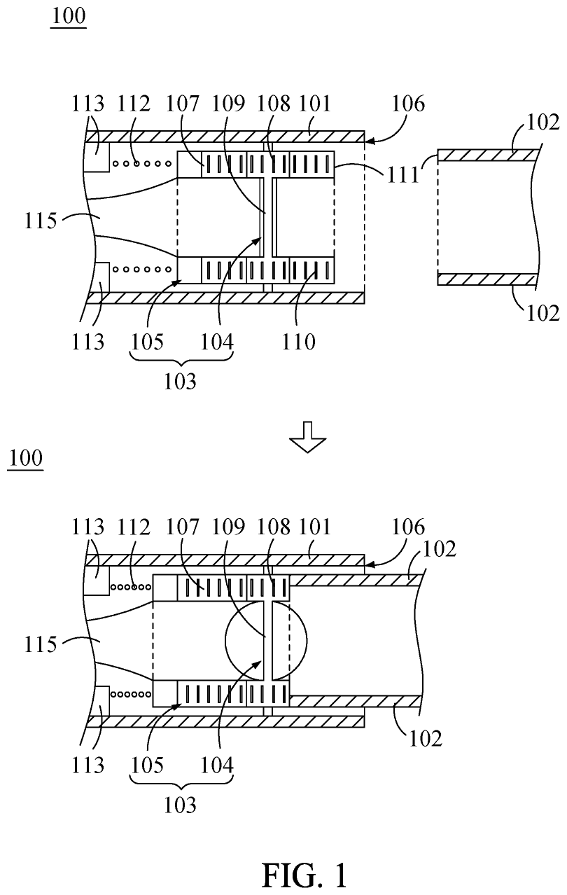

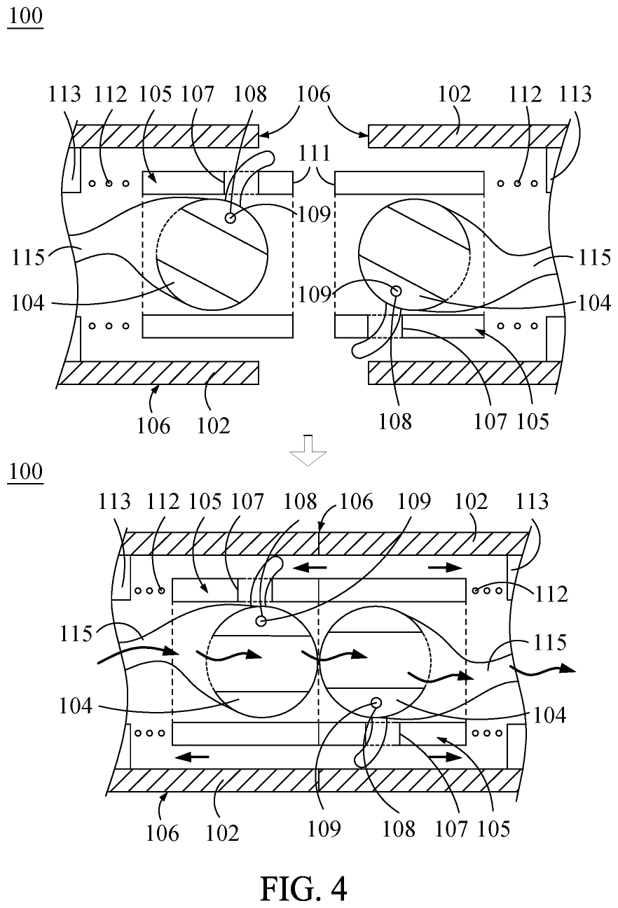

Referring to FIG. 1, FIG. 4 and FIG. 8 to FIG. 11, a communicating structure 100 applied to a first communicating body 101 and including a door assembly 103 is provided according to a first aspect of the present disclosure. The door assembly 103 is assembled in the first communicating body 101, and includes a door 104 movably connected to the first communicating body 101 and a connecting structure 105 allowing movement of the door 104. The connecting structure 105 includes an actuating portion 107, and the door 104 is provided with a connecting portion 108. The actuating portion 107 is for acting on the connecting portion 108 or performing a lever operation on the connecting portion 108 so as to move the door 104.

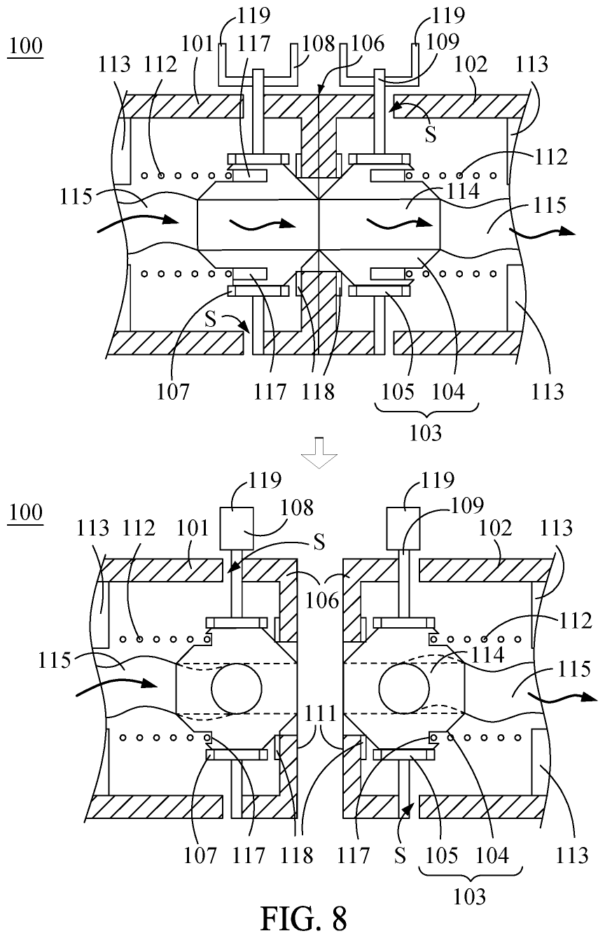

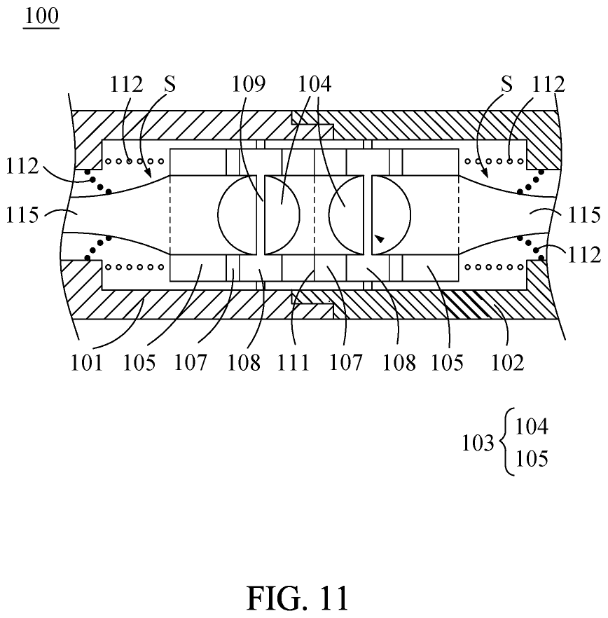

Referring to FIG. 4, FIG. 8 and FIG. 11, a communicating structure 100 applied to a first communicating body 101 is further provided according to a second aspect of the present disclosure. The communicating structure 100 includes a door assembly 103. The door assembly 103 may further include a sealing section 115. The door 104 of the door assembly 103 may have an opening 114, and the sealing section 115 may be assembled or sealed at the opening 114 or a part of the door assembled 103 that is not the door 104, so as to communicate a fluid. The fluid may be a liquid fluid, a gas fluid or a solid fluid. The sealing section 115 may be a pipe, a hard pipe, a bolt connector, a flexible pipe, a plug, a barrel, a sleeve, a sheath, a locking connector, an engaging connector or a welding connector. Two doors 104 are used for connection so as to communicate a fluid, and the fluid can be communicated without loss. The sealing section 115 can be sealed with the door 104, so the first communicating body 101 does not need to be provided with a sealing structure or a stop portion.

As described above, by merely plugging or unplugging the first communicating body 101 with respect to another communicating body, the first communicating body 101 is allowed to quickly communicate with or be separated from the another communicating body, thereby achieving the goal of simplifying an operation process.

As shown in FIG. 1, FIG. 4 and FIG. 8, in one embodiment, the first communicating body 101 is for connecting to a second communicating body 102. The second communicating body 102 is similarly assembled with the door assembly 103 therein. Similar to the first communicating body 101, the door assembly 103 corresponding to the second communicating body 102 also includes a door 104 movably connected to the second communicating body 102, and a connecting structure 105 allowing movement of the door 104; the connecting structure 105 and the door 104 similarly respectively include an actuating portion 107 and a connecting portion 108. When the first communicating body 101 is connected to the second communicating body 102, the actuating portion 107 is pushed and moved by the second communicating body 102 to push the connecting portion 108 such that the gate 104 is moved and opened so as to be in communication with the second communicating body 102. Alternatively, when the first communicating body 101 is separated from the second communicating body 102, the connecting structure 105 moves, resets and closes the door 104. As shown in FIG. 3, the connecting structure 105 may slightly protrude from the first communicating body 101 before conducting one first communicating body 101 to the other one.

Referring to FIG. 1, FIG. 4 and FIG. 8, in one embodiment, each of the first communicating body 101 and the second communicating body 102 includes a combining portion 106 for assembly or sleeving. Specifically, the first communicating body 101 may be sleeved with the combining portion 106 of the second communicating body 102, or the second communicating body 102 may be sleeved with the combining portion 106 of the first communicating body 101. For example, in FIG. 1, the first communicating body 101 and the second communicating body 102 are sleeved through the combining portion 106, and the combining portion 106 may be on an inner or outer side of the first communicating body 101 or the second communicating body 102. For example, in FIG. 4 and FIG. 8, the first communicating body 101 and the second communicating body 102 are assembled through the combining portion 106, and the combining portion 106 may be a pipe opening of the first communicating body 101 or the second communicating body 102.

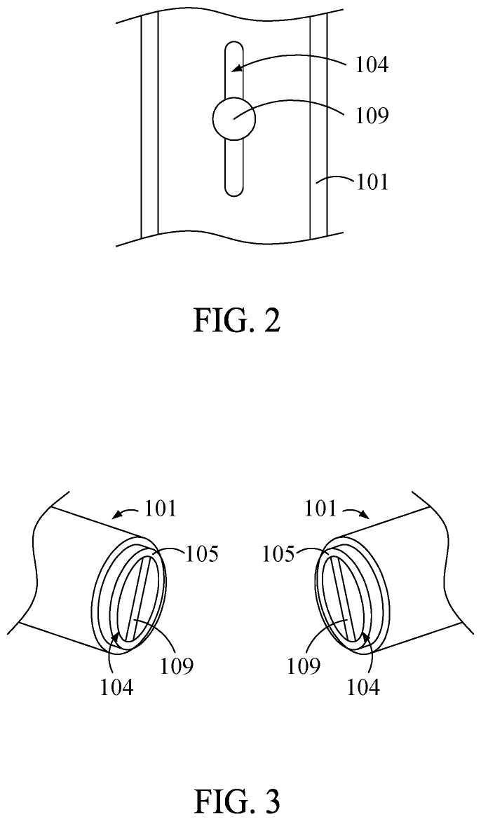

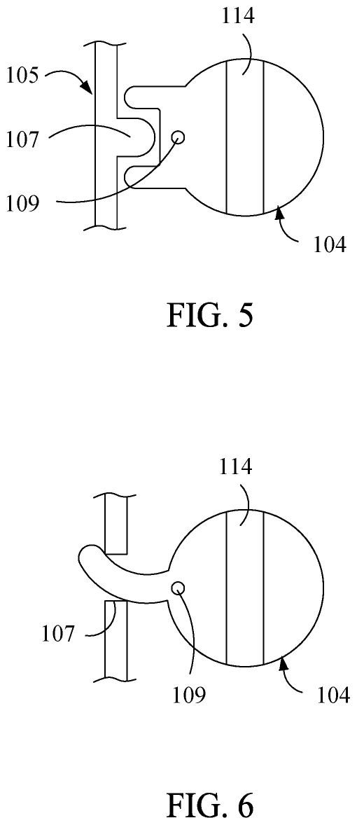

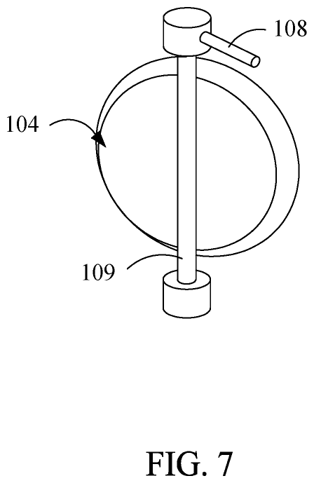

Referring to FIG. 1, FIG. 4 to FIG. 7 and FIG. 8, in one embodiment, the connecting portion 108 may be a rod (as in FIG. 7), a hole, a protrusion (as in FIG. 6), a recess (as in FIG. 5), an arched body, a manually controlled body (as in FIG. 8), an operated body (as in FIG. 8), a curved body, a concave-convex body (as in FIG. 1) or a wheel (as in FIG. 1). The actuating portion 107 of the connecting structure 105 may be a protrusion (as in FIG. 5), a recess (as in FIG. 6), an arched body, a concave-convex body (as in FIG. 1), a curved body, a hole, a slot, a rod (as in FIG. 4) or a column or a wheel (as in FIG. 1). The door 104 may be a disk, a plate, a ball, a rugby-shaped body, an ellipsoid, a shaft, a protrusion, a recess, a through hole body (as in FIG. 4), a through slot body (as in FIG. 4), a disk body (as in FIG. 7) or a door body (as in FIG. 2 and FIG. 3). The actuating portion 107 is for acting on the connecting portion 108 or for moving relative to the connecting portion 108. The door 104 may have a shaft 109 connected to the connecting portion 108. The shaft 109 is assembled, movably assembled or axially movably assembled with the first communicating body 101, so as to move, for example, rotating, turning or moving, the door 104 when the connecting portion 108 receives a relative movement or is collaterally moved by the action of the actuating portion 107. In FIG. 4 and FIG. 8, when the second communicating body 102 also includes the door assembly 103, the shaft 109 is also assembled, movably assembled or axially movably assembled with the second communicating body 102.

For example, in FIG. 1, the connecting portion 108 is a concave-convex body, and the actuating portion 107 has a rack 110. For another example, in FIG. 5 or FIG. 6, the connecting portion 108 is a triggered portion and the actuating portion 107 is a triggering portion. In FIG. 5, the connecting portion 108 is a triggered recess and the actuating portion 107 is a triggering recess; in FIG. 6, the connecting portion 108 is a triggered protrusion and the actuating portion 107 is a triggering hole.

As shown in FIG. 8 and FIG. 10, the door assembly 103 may also include an operating portion 119 for manually controlling or non-manually controlling the door assembly 103; for example, for operating the connecting structure 105 in the door assembly 103, or specifically, for operating the actuating portion 107 of the connecting structure 105. In FIG. 8, the connecting portion 108 may also be operated and thus has the operating portion 119. In FIG. 10, the operating portion 119 is a bent rod suitable for being pulled and in FIG. 8, the operating portion 119 is a rotating button suitable for being operated by rotation.

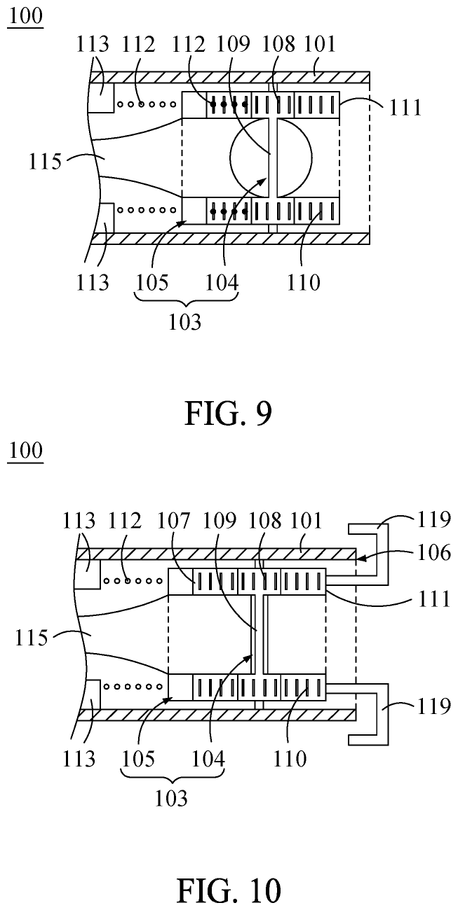

As shown in FIG. 1, FIG. 4 and FIG. 8 to FIG. 11, in one embodiment, the communicating structure 100 may further include an elastic element 112. Two ends of the elastic element 112 are respectively pressed against the block portions 113 on the inner sides of the connecting structure 105 and the first communicating body 101. However, the two ends of the elastic element 112 may also be respectively pressed against a part of the door assembly 103 that is not the connecting structure 105 and the first communicating body 101. For example, in FIG. 9, another elastic element 112 pressing between the connecting portion 108 and the connecting structure 105 is further provided. As shown in FIG. 8, the first communicating body 101 or the second communicating body 102 may have a floating space S for elastic pressing of the elastic element 112. The block portion 113 may be a convex ring, and the elastic element 112 may be a coil spring; however, the present disclosure is not limited to the examples above. The elastic element 112 provides the connecting structure 105 an elastic force for positioning the door 104 at a closed position. For example, when the first communicating body 101 is unplugged from the second communicating body 102, the connecting structure 105 can be reset to further restore the door 104 back to the closed position. In FIG. 4, FIG. 8 and FIG. 11, the second communicating body 102 is also provided with the door assembly 103, and is thus also provided with the elastic element 112. Moreover, in FIG. 8, the two ends of the elastic element 112 may also be pressed against the doors 104 respectively corresponding to the first communicating body 101 or the second communicating body 102. The door 101 in FIG. 8 is capable of moving horizontally, and the connecting structure 105 is fixed at the first communicating body 101 or the second communicating body 102. Each door 104 may be provided with a storage portion 117 for arranging the elastic element 112. The storage portion 117 may be a portion at a non-turning top or bottom portion of the door 104, and the storage portion 117 may be a recess for fitting the elastic element 112, so that the elastic element 112 does not become shifted. The storage portion 117 may b e pivotally connected to a part of the door 104 having the opening 114. However, the storage portion 117 may also be disposed at a part of the door assembly 103 that is not provided with the door 104. Moreover, the combining portion 106 in FIG. 8 is inwardly bent and withdrawn in the first communicating body 101 or the second communicating body 102, so as to prevent the door 104 from falling out of the first communicating body 101 or the second communicating body 102. The combining portion 106 is provided with a buffer portion 118 on an inner side, so as to prevent the door 104 from interfering with the combining portion 106 when the door 104 rotates and hence from damage. The buffer portion 118 may be an element with a buffering function, for example, rubber or silicone. In FIG. 4, FIG. 8 and FIG. 11, the two ends of the elastic element 112 may also be pressed against the sealing section 115 and the first communicating body 101 or the second communicating body 102.

In FIG. 1, the second communicating body 102 may be a connector for, for example, directly supplying a fluid to the first communicating body 101 or receiving a fluid from the first communicating body 101. Again referring to FIG. 4, FIG. 8 and FIG. 11, similar to the first communicating body 101, the second communicating body 102 may also be provided with the door 104 and the connecting structure 105, that is, provided with the door assembly 103. When the second communicating body 102 is also provided with the door 104 and the connecting structure 105, in order to at the same time achieve moving of the door 104 while connecting, the connecting structure 105 in the second communicating body 102 may further be provided with a corresponding portion 111 so as to push the connecting structure 105 in the first communicating body 101. The first communicating body 101 in FIG. 1 may be regarded as the corresponding portion 111 with respect to the connecting structure 105 of the second communicating body 102. In FIG. 4, the actuating portion 107 of the connecting structure 105 may move along a track or a chute (not shown) arranged at the first communicating body 101 or the second communicating body 102, and an end of the track or the chute may practice the function of the corresponding portion 111 above.

As shown in FIG. 1, FIG. 4 and FIG. 8 to FIG. 11, when the first communicating body 101 is connected to the second communicating body 102, the first communicating body 101 itself or the actuating portion 107 of the connecting structure 105 or another part of the first communicating body 101 may push against the corresponding portion 111, the combining portion 106, the actuating portion 107 of the connecting structure 105 or another part of the second communicating body 102. Similarly, the second communicating body 102 itself or the actuating portion 107 of the connecting structure 105 or another part of the second communicating body 102 may push against the corresponding portion 111, the combining portion 106, the actuating portion 107 of the connecting structure 105 or another part of the first communicating body 101. For example, in FIG. 11, the respective connecting structures 105 of the first communicating body 101 and the second communicating body 102 push against each other so as to open the two doors 104. The sealing section 115 of FIG. 11 is assembled at the connecting structure 105. In FIG. 11, apart from the elastic element 112 pushing between the connecting structure 105 and the first communicating body 101 or the second communicating body 102, another elastic element 112 pushing between the sealing section 115 and the first communicating body 101 or the second communicating body 102 may also be provided. The elastic element 112 pushing between the sealing section 115 and the first communicating body 101 or the second communicating body 102 may be a coil spring, one end of the elastic element 112 having a narrow aperture is pressed against the sealing section 115, and one end with a wide aperture is pressed against the first communicating body 101 or the second communicating body 102. As shown in FIG. 11, the two types of elastic elements 112 may exist at the same time, or only one between the two may be selectively provided.

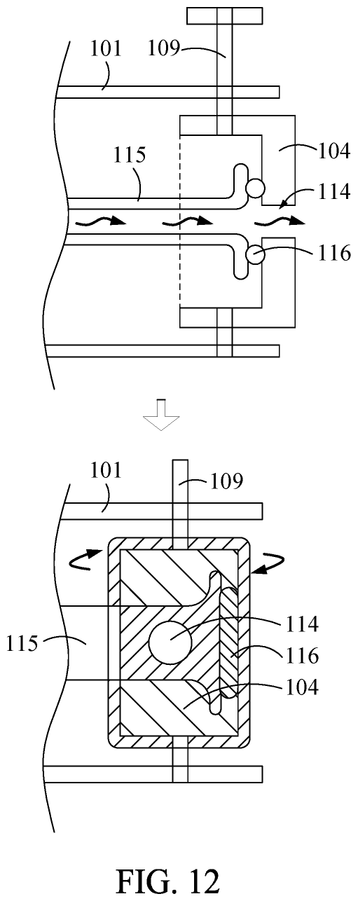

As shown in FIG. 12, in one embodiment, the sealing section 115 may correspond to or be shifted from the opening 114 of the door 104. Specifically, the sealing section 115 may be kept unmoved, and the door 104 may correspond to or be shifted from the sealing section 115 by means of rotation, so as to have the sealing section 115 allow communication of the fluid or be closed. However, the present disclosure is not limited to the examples above; the door 104 may also be assembled to or disengaged from the sealing section 115 by means of rotation or other means of movement. The upper half of FIG. 12 shows that the sealing section 115 corresponds to the opening 114, and the lower half of FIG. 12 shows that the door 104 is rotated such that the opening 114 is shifted from the sealing section 115; meanwhile, the door is provided with the stop portion 116 so as to close the sealing section 115 when the opening 114 is shifted from the sealing section 115. Although the sealing section 115 and the door 104 that can be disengaged or assembled are provided at the first communicating body 101 according to FIG. 12, they can be applied to the second communicating body 102 shown in the other drawings.

The present disclosure is described by way of the preferred embodiments above. A person skilled in the art should understand that, these embodiments are merely for describing the present disclosure and are not to be construed as limitations to the scope of the present disclosure. It should be noted that all equivalent changes, replacements and substitutions made to the embodiments are to be encompassed within the scope of the present disclosure. Therefore, the scope of protection of the present disclosure should be accorded with the broadest interpretation of the appended claims.

What is claimed is:

1. A communicating structure, applied to a first communicating body, the communicating structure comprising
a door assembly, assembled in the first communicating body, the door assembly comprising a door movably connected to the first communicating body, and a connecting structure allowing movement of the door, wherein the connecting structure comprises an actuating portion, the door is provided with a connecting portion, and the actuating portion is for acting on the connecting portion or performing a lever operation on the connecting portion so as to move the door.

2. A communicating structure, applied to a first communicating body, the communicating structure comprising:
a door assembly, disposed in the first communicating body, the door assembly comprising a door movably connected to the first communicating body, the door assembly further comprising a sealing section, or the door having an opening, or the sealing section being assembled or sealed at the opening, or the sealing section being assembled or sealed at a non-door portion, so as to communicate a fluid.

3. The communicating structure according to claim 1, wherein the first communicating body or the second communicating body has a combining portion for sleeving or combining, or the respective combining portions of the first communicating body and the second communicating body are pipes sleeved with each other, or the combining portion of the second communicating body or the first communicating body is a pipe.

4. The communicating structure according to claim 1, further comprising an elastic element, two ends of the elastic elements respectively pressing against the connecting structure and the first communicating body, or the two ends of the elastic element respectively pressing against the first communicating body and the door, or the two ends of the elastic element respectively pressing against a part of the door assembly that is not the connecting structure and the first communicating body; or when a second communicating body is provided with the door assembly, the two ends of the elastic element respectively pressing against the connecting structure and the second communicating body, or the two ends of the elastic element respectively pressing against the second communicating body and the door, or the two ends of the elastic element respectively pressing against a part of the door assembly that is not the connecting structure and the second communicating body.

5. The communicating structure according to claim 1, wherein the door assembly further comprises a sealing section, the door has an opening, and the sealing section is assembled or seals at the opening so as to communicate the fluid.

6. The communicating structure according to claim 2, wherein the sealing section is a pipe, a hard pipe, a bolt connector, a flexible pipe, a plug, a barrel, a sleeve, a sheath, a locking connector, an engaging connector or a welding connector.

7. The communicating structure according to claim 1, wherein the door has a shaft, and the shaft is assembled, movably assembled or axially movably assembled with the first communicating body, or the shaft is assembled, movably assembled or axially movably assembled with the second communicating body.

8. The communicating structure according to claim 1, wherein the first communicating body is for connecting to a second communicating body, the second communicating body is also provided with the door assembly, the door assembly comprises a door movably connected to the second communicating body and a connecting structure for allowing movement of the door, wherein the connecting structure and the door corresponding to the second communicating body respectively comprise an actuating portion and a connecting portion, and the actuating portion is for acting on the connecting portion or performing a lever operation on the connecting portion so as to move the door.

9. The communicating structure according to claim 1, wherein the first communicating body is connected to a second communicating body, the second communicating body is provided with the door assembly, the connecting structure of the door assembly is further provided with a corresponding portion, or the second communicating body is further provided with a combining portion, or the second communicating body is for pushing the actuating portion or a part of the connecting structure that is not the actuating portion of the first communicating body, or the combining portion, the corresponding portion of the connecting structure or the actuating portion of the second communicating portion is for pushing the actuating portion of the connecting structure or another part of the first communicating body, or the first communicating body is for pushing the actuating portion of the connecting structure or another part of the second communicating body, or the first communicating body is provided with the combining portion or the connecting structure of the first communicating structure is provided with the corresponding portion, and the actuating portion, the combining portion and the corresponding portion of the first communicating body is for pushing the actuating portion of the connecting structure or a part that is not the actuating portion of the second communicating body.

10. The communicating structure according to claim 1, wherein the first communicating body is connected to a second communicating body, the actuating portion is pushed and moved by the second communicating body to push the connecting portion such that the door is moved and opened so as to be in communication with the second communicating body, or when the first communicating body is separated from the second communicating body, the connecting structure moves, resets and closes the door.

11. The communicating structure according to claim 1, wherein the first communicating body or the second communicating body has a floating space for elastic pushing of an elastic element.

12. The communicating structure according to claim 1, wherein the door assembly has an operating portion for manually or non-manually controlling and operating the door assembly, or the connecting structure in the door assembly, or the actuating portion in the connecting structure.

13. The communicating structure according to claim 4, wherein the door or a part of the door assembly that does not comprise the door has a storage portion for arranging the elastic element.

14. The communicating structure according to claim 2, further comprising an elastic element, two ends of the elastic element respectively pressing against the first communicating body and the door, or the two ends of the elastic element respectively pressing against the sealing section and the first communicating body; or when a second communicating body is provided with the door assembly, the two ends of the elastic element respectively pressing against the connecting structure and the second communicating body, or the two ends of the elastic element respectively pressing against the sealing section and the second communicating body, or the two ends of the elastic element respectively pressing against a part of the door assembly that is not the connecting structure and the second communicating body.

15. The communicating structure according to claim 1, wherein the door assembly further comprises a sealing section, the door has an opening, the sealing section is for corresponding to or shifting from the opening, or the sealing section is kept unmoved, or the door is for corresponding to or shifting from the sealing section by means of rotating, turning or moving, so as to have the sealing section communicate a fluid or be closed.

16. The communicating structure according to claim 2, wherein the door assembly further comprises a sealing section, the door has an opening, the sealing section is for corresponding to or shifting from the opening, or the sealing section is kept unmoved, or the door is for corresponding to or shifting from the sealing section by means of rotating, turning or moving, so as to have the sealing section communicate a fluid or be closed.

17. The communicating structure according to claim 1, further comprising a stop portion, the stop portion being arranged on the first communicating body, the second communicating body, the door assembly, the door, the connecting structure, the corresponding portion, the combining portion, the actuating portion, the sealing section or another part, or between the elements above, or between combinations of the elements above, so as to seal a fluid.
